(19) United States
(12) Patent Application Publication
(10) Pub. No.: US 2025/0172328 A1
(43) Pub. Date: May 29, 2025

(54) Car refrigerator installation method and installation structure

(71) Applicant: Gangyao Long, Foshan (CN)

(72) Inventor: Gangyao Long, Foshan (CN)

(21) Appl. No.: 19/037,633

(22) Filed: Jan. 27, 2025

(30) Foreign Application Priority Data
Dec. 1, 2024 (CN) CN 202411744676.1

(51) Int. Cl. F25D 11/00

(52) U.S. Cl. CPC F25D 11/00

(57) ABSTRACT

The present disclosure provides a car refrigerator installation method, including: dismantling one of limiting strips; pushing a refrigerator main body horizontally from a side where the limiting strip is dismantled to abut against the other limiting strip; and installing the dismantled limiting strip so that the limiting strip clamps the refrigerator main body together with the other limiting strip. The dismantlable limiting strips are used to make room for the refrigerator main body to pass, and fix the refrigerator main body after the refrigerator main body reaches a designated position, so dismantling and installing processes of a car refrigerator are convenient and fast. The present disclosure further provides a car refrigerator installation structure.

### CROSS-REFERENCE TO RELATED APPLICATIONS

The present application claims priority to Chinese Patent Application No. CN 202411744676.1, filed on Dec. 1, 2024, the content of which is incorporated herein by reference in its entirety.

### TECHNICAL FIELD

The present disclosure relates to the technical field of auto spare parts, in particular to a car refrigerator installation method and installation structure.

### BACKGROUND

With the progress of social development, cars have become the primary means of transportation. Due to their convenience, car refrigerators are being increasingly widely used.

Typically, car refrigerators are small and standalone refrigerators placed inside vehicles. However, during vehicle driving, especially on bumpy roads, it is difficult to ensure the stability of the car refrigerators. Additionally, the limited interior spaces of the vehicles often result in smaller refrigerator capacities, leading to poor user experience.

To address the problem, car refrigerators that are compatible with interior vehicle spaces and can be installed in vehicles through retrofitting have emerged on the market. These retrofitted car refrigerators provide car owners with larger refrigeration compartments and are basically integrated into vehicle's structures, offering excellent stability. However, retrofitting often requires modifying part of the vehicle's structures, which can affect aesthetics and make it inconvenient for car owners to install or remove the refrigerators based on their specific needs.

### SUMMARY

In view of this, it is necessary to propose a car refrigerator installation method and installation structure facilitating stable, convenient and rapid dismantling and installation.

The present disclosure provides a car refrigerator installation method. A car refrigerator includes a refrigerator main body and a pair of limiting strips which are parallel to each other and are arranged at an interval on an interior floor of a vehicle to limit the refrigerator main body, and the method includes the following steps:

S100, dismantling one of the limiting strips;

S200, pushing the refrigerator main body horizontally from a side where the limiting strip is dismantled to abut against the other limiting strip; and

S300, installing the dismantled limiting strip so that the limiting strip clamps the refrigerator main body together with the other limiting strip.

Preferably, at least one of the limiting strips includes a first part and a second part which are separatable, and step S100 includes dismantling the first part and then dismantling the second part.

Preferably, step S300 includes installing the second part and then installing the first part.

Preferably, the refrigerator main body includes a first installation part connected with the first part and a second installation part connected with the second part, a plurality of installation bumps are arranged at a position, corresponding to the second part, on the interior floor of the vehicle, yielding parts are arranged on the second installation part, and step S200 includes pushing the refrigerator main body after aligning the yielding parts to at least one of the installation bumps.

The car refrigerator installation method provided by the present disclosure includes: dismantling one of the limiting strips; pushing the refrigerator main body horizontally from the side where the limiting strip is dismantled to abut against the other limiting strip; and installing the dismantled limiting strip so that the limiting strip clamps the refrigerator main body together with the other limiting strip. The dismantlable limiting strips are used to make room for the refrigerator main body to pass, and fix the refrigerator main body after the refrigerator main body reaches a designated position, so dismantling and installing processes of the car refrigerator are convenient and fast.

The present disclosure further provides a car refrigerator installation structure. The structure includes a refrigerator main body and a pair of limiting strips which are parallel to each other and are arranged at an interval on an interior floor of a vehicle to limit the refrigerator main body, a plurality of installation bumps used for fixing the limiting strips are arranged on the interior floor of the vehicle, and yielding parts corresponding to the installation bumps are arranged at a bottom of the refrigerator main body.

Preferably, at least one of the limiting strips includes a first part and a second part which are separatable.

Preferably, the refrigerator main body includes a first installation part connected with the first part and a second installation part connected with the second part, and the yielding parts are located on the second installation part.

The car refrigerator installation structure provided by the present disclosure includes the refrigerator main body and the pair of limiting strips which are parallel to each other and are arranged at an interval on the interior floor of the vehicle to limit the refrigerator main body, the plurality of installation bumps used for fixing the limiting strips are arranged on the interior floor of the vehicle, and the yielding parts corresponding to the installation bumps are arranged at the bottom of the refrigerator main body. Through the arrangement of the yielding parts, the refrigerator main body can smoothly pass the installation bumps and the car refrigerator is convenient to install.

### BRIEF DESCRIPTION OF DRAWINGS

In order to more clearly explain specific implementations of the present disclosure or the technical solution in the prior art, the drawings to be used in the description of the specific implementations or the prior art will be briefly described below. Apparently, the drawings in following description are some implementations of the present disclosure. For those ordinarily skilled in the art, other drawings may also be obtained based on these drawings without inventive efforts.

FIG. 1 is a schematic constitutional diagram of a car refrigerator installation structure provided by an embodiment.

FIG. 2 is an exploded view of a car refrigerator installation structure provided by an embodiment.

FIG. 3 is a flow chart of a car refrigerator installation method provided by an embodiment.

FIG. 4 is a schematic diagram of yielding parts matching with installation bumps provided by an embodiment.

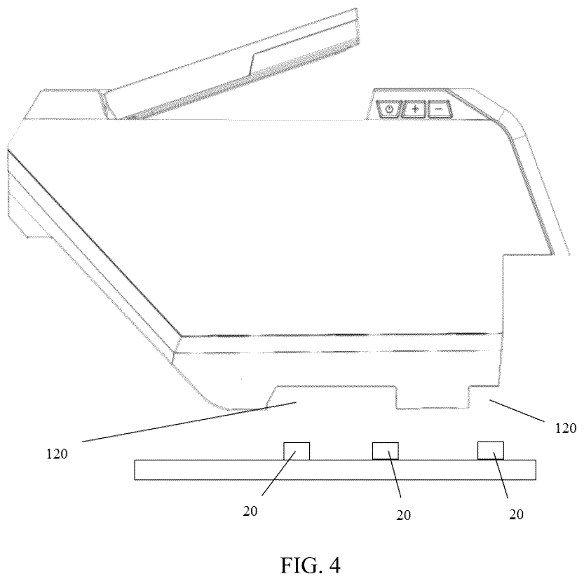

### DESCRIPTION OF EMBODIMENTS

Technical solutions of the present disclosure will be clearly and completely described below in conjunction with accompanying drawings. Apparently, the described embodiments are a part of the embodiments of the present disclosure, not all of them. Based on the described embodiments of the present disclosure, all other embodiments obtained by those ordinarily skilled in the art without the need for creative labor fall within the scope of protection of the present disclosure.

In the description of the present disclosure, it should be noted that the orientation or positional relationship indicated by the terms “center”, “upper”, “lower”, “left”, “right”, “vertical”, “horizontal”, “inner”, “outer”, etc. is based on the orientation or positional relationship shown in the drawings, is merely to facilitate the description of the present disclosure and simplify the description, does not indicate or imply that apparatuses or elements referred to must have a particular orientation or be constructed and operated in a particular orientation, and thus should not be construed as limiting the present disclosure. In addition, terms such as “first”, “second” and “third” are merely for description and should not be understood as indicating or implying any relative significance.

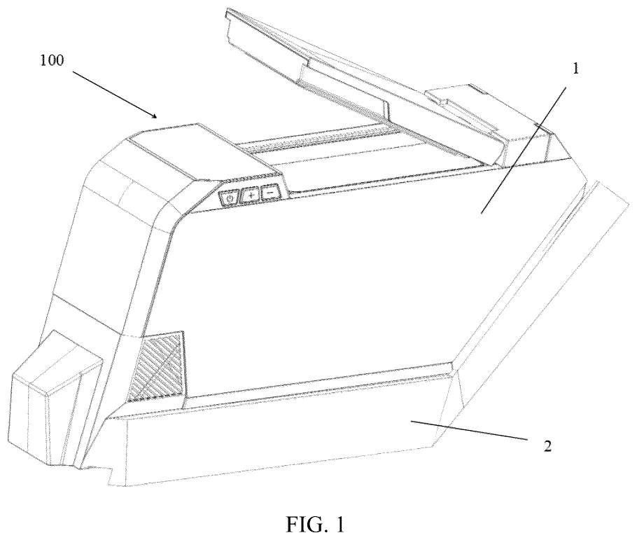

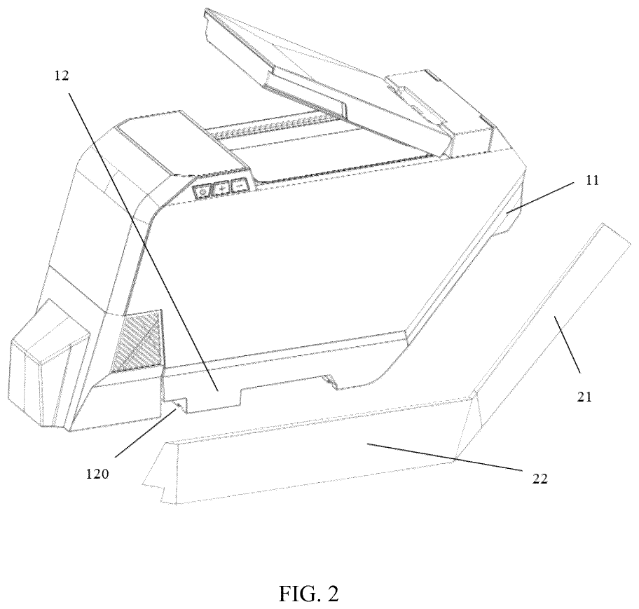

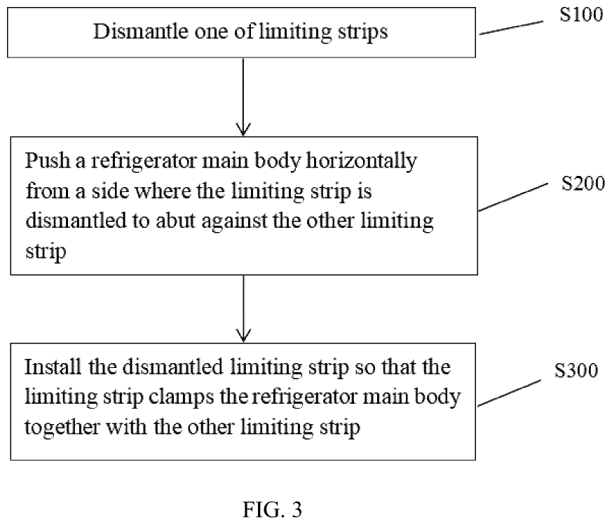

As shown in FIG. 1 to FIG. 3, the present disclosure provides a car refrigerator installation method. A car refrigerator 100 includes a refrigerator main body 1 and a pair of limiting strips 2 which are parallel to each other and are arranged at an interval on an interior floor of a vehicle to limit the refrigerator main body 1.

The car refrigerator installation method provided by the present disclosure includes the following steps:

S100, one of the limiting strips is dismantled. In the embodiment, the refrigerator main body 1 is installed between front seats of the vehicle, that is between a driver's seat and a front passenger seat, and has a contour matching with the corresponding space in the vehicle. One of the limiting strips 2 is close to the driver's seat and the other one is close to the front passenger seat. In an installation process of the car refrigerator 100, the limiting strip 2 close to the front passenger seat may be dismantled, to make enough room for the refrigerator main body 1 to smoothly pass. It should be understood that in other embodiments, the limiting strip 2 close to the driver's seat may be dismantled.

S200, the refrigerator main body is horizontally pushed from a side where the limiting strip is dismantled to abut against the other limiting strip. Because the installed refrigerator main body 1 will be clamped by the two limiting strips 2 to maintain stability, by pushing the refrigerator main body 1 horizontally from the side where the limiting strip 2 is dismantled to abut against the other limiting strip 2, it may be ensured that the position of the refrigerator main body 1 is not deviated and installation is accurate.

S300, the dismantled limiting strip is installed so that the limiting strip clamps the refrigerator main body together with the other limiting strip. A width at a bottom of the refrigerator main body 1 matches with the two limiting strips 2. After the refrigerator main body 1 reaches a preset position, the dismantled limiting strip 2 is then installed at the original position, and therefore the refrigerator main body 1 may be firmly clamped.

Preferably, least one of the limiting strips 2 includes a first part 21 and a second part 22 which are separatable; step S100 includes dismantling the first part 21 and then dismantling the second part 22; and step S300 includes installing the second part 22 and then installing the first part 21. In the embodiment, an included angle between the first part 21 and the second part 22 is an obtuse angle, the second part 22 is a horizontal part and the first part 21 is an inclined part. By dividing one limiting strip 2 into two separatable parts, a rigid structure of the limiting strip 2 is not prone to damage during dismantling and installation of the limiting strip 2.

Further, the refrigerator main body 1 includes a first installation part 11 connected with the first part 21 and a second installation part 12 connected with the second part 22. A plurality of installation bumps 20 are arranged at a position, corresponding to the second part, on the interior floor of the vehicle. Yielding parts 120 are arranged on the second installation part 12. Step S200 includes pushing the refrigerator main body 1 after aligning the yielding parts 120 to at least one of the installation bumps 20. By virtue of the yielding parts 120 corresponding to the installation bumps, the refrigerator main body 1 may conveniently slide to a preset position and be positioned, so that the refrigerator main body 1 does not deviate during sliding.

It may be understood that when it is necessary to remove the car refrigerator 100, similar steps may also be adopted. One of the limiting strips 2 is dismantled, the refrigerator main body 1 is pushed, toward a direction of the dismantled limiting strip 2, away from an installation position, the dismantled limiting strip 2 is then installed at the original position, and the original structure of the vehicle at the position may be restored. Perforating is not needed to damage the interior of the vehicle, and no complex dismantling and installation processes are involved.

The car refrigerator installation method provided by the present disclosure includes: one of the limiting strips is dismantled; the refrigerator main body is pushed horizontally from the side where the limiting strip is dismantled to abut against the other limiting strip; and the dismantled limiting strip is installed so that the limiting strip clamps the refrigerator main body together with the other limiting strip. The dismantlable limiting strips are used to make room for the refrigerator main body to pass, and fix the refrigerator main body after the refrigerator main body reaches a designated position, so dismantling and installing processes of the car refrigerator are convenient and fast.

The present disclosure further provides a car refrigerator installation structure 10. The structure includes a refrigerator main body 1 and a pair of limiting strips 2 which are parallel to each other and are arranged at an interval on an interior floor of a vehicle to limit the refrigerator main body 1, a plurality of installation bumps 20 used for fixing the limiting strips 1 are arranged on the interior floor of the vehicle, and yielding parts 120 corresponding to the installation bumps 20 are arranged at a bottom of the refrigerator main body 1.

Preferably, at least one of the limiting strips 2 includes a first part 21 and a second part 22 which are separatable. The refrigerator main body 1 includes a first installation part 11 connected with the first part 21 and a second installation part 12 connected with the second part 22, and the yielding parts 120 are located on the second installation part 12.

In the embodiment, the yielding parts 120 are a plurality of through grooves passing through the bottom of the refrigerator main body 1 along a direction perpendicular to the two limiting strips 2. It may be understood that the number of the yielding parts 120 may correspond to the number of the installation bumps 20, or may be smaller than the number of the installation bumps 20. For example, one through groove may cross two or more installation bumps 20, as long as the yielding parts 120 can avoid all the installation bumps 20.

The car refrigerator installation structure provided by the present disclosure includes the refrigerator main body and the pair of limiting strips which are parallel to each other and are arranged at an interval on the interior floor of the vehicle to limit the refrigerator main body, the plurality of installation bumps used for fixing the limiting strips are arranged on the interior floor of the vehicle, and the yielding parts corresponding to the installation bumps are arranged at the bottom of the refrigerator main body. Through the arrangement of the yielding parts, the refrigerator main body can smoothly pass the installation bumps and the car refrigerator is convenient to install.

The above embodiments are provided solely to illustrate the technical solutions of the present disclosure and should not be construed as limitations. Although the present disclosure has been described in detail with reference to the aforementioned embodiments, it should be understood by those ordinarily skilled in the art that modifications can still be made to the technical solutions described in the above embodiments, or some or all of the technical features can be replaced with equivalent replacements. Such modifications or replacements do not depart from the scope of the technical solutions described in the embodiments of the present disclosure.

What is claimed is:

1. A car refrigerator installation method, wherein a car refrigerator comprises a refrigerator main body and a pair of limiting strips which are parallel to each other and are arranged at an interval on an interior floor of a vehicle to limit the refrigerator main body, and the method comprises the following steps:
S100, dismantling one of the limiting strips;
S200, pushing the refrigerator main body horizontally from a side where the limiting strip is dismantled to abut against the other limiting strip; and
S300, installing the dismantled limiting strip so that the limiting strip clamps the refrigerator main body together with the other limiting strip.

2. The car refrigerator installation method according to claim 1, wherein at least one of the limiting strips comprises a first part and a second part which are separatable, and step S100 comprises dismantling the first part and then dismantling the second part.

3. The car refrigerator installation method according to claim 2, wherein step S300 comprises installing the second part and then installing the first part.

4. The car refrigerator installation method according to claim 1, wherein the refrigerator main body comprises a first installation part connected with the first part and a second installation part connected with the second part, a plurality of installation bumps are arranged at a position, corresponding to the second part, on the interior floor of the vehicle, yielding parts are arranged on the second installation part, and step S200 comprises pushing the refrigerator main body after aligning the yielding parts to at least one of the installation bumps.

5. A car refrigerator installation structure, comprising a refrigerator main body and a pair of limiting strips which are parallel to each other and are arranged at an interval on an interior floor of a vehicle to limit the refrigerator main body, wherein a plurality of installation bumps used for fixing the limiting strips are arranged on the interior floor of the vehicle, and yielding parts corresponding to the installation bumps are arranged at a bottom of the refrigerator main body.

6. The car refrigerator installation structure according to claim 5, wherein at least one of the limiting strips comprises a first part and a second part which are separatable.

7. The car refrigerator installation structure according to claim 6, wherein the refrigerator main body comprises a first installation part connected with the first part and a second installation part connected with the second part, and the yielding parts are located on the second installation part.
